(19) United States
(12) Patent Application Publication
(10) Pub. No.: US 2026/0094255 A1
(43) Pub. Date: Apr. 2, 2026

(54) METHOD FOR DETECTING A DEFECT IN A VIA, DETECTION DEVICE, STORAGE MEDIUM AND EVALUATION DEVICE

(71) Applicant: Siemens Healthineers AG, Forchheim (DE)

(72) Inventors: Benedikt Christopher VOGT-WOLZ, Erlangen (DE); Jan WREGE, Erlangen (DE)

(73) Assignee: Siemens Healthineers AG, Forchheim (DE)

(21) Appl. No.: 19/347,964

(22) Filed: Oct. 2, 2025

(30) Foreign Application Priority Data
Oct. 2, 2024 (DE) 10 2024 209 676.8

(51) Int. Cl. G06T 7/00; G06T 7/11

(52) U.S. Cl. CPC G06T 7/0004; G06T 7/11; G06T 2207/10056; G06T 2207/20081; G06T 2207/20084; G06T 2207/30148

(57) ABSTRACT

A method for detecting at least one defect in at least one hollow via of a microelectronic component, the method comprising: acquiring, via an image acquisition device, image data of a hollow interior space of the via relating to at least a part of the visually visible range of the electromagnetic spectrum; supplying the image data to an evaluation device; and evaluating the image data to identify the at least one defect.

### CROSS-REFERENCE TO RELATED APPLICATION(S)

The present application claims priority under 35 U.S.C. § 119 to German Patent Application No. 10 2024 209 676.8, filed Oct. 2, 2024, the entire contents of which are incorporated herein by reference.

### FIELD

One or more example embodiments of the present invention relate to a method, in particular a computer-implemented method, for detecting at least one defect in at least one hollow via of a microelectronic component.

### BACKGROUND

Microelectronic components comprising e.g. a plate-shaped silicon substrate on which microelectronic components are mounted and/or formed frequently include vias by which an electrical contact is established in each case from a top side to a bottom side of the respective component. Vias typically comprise a number of layers, arranged in a stack one on top of the other, serving for insulation and contacting purposes. Vias of this type may either be filled with an electrically conductive material, e.g. copper, or have a hollow interior space, the present invention relating to the second case in which the vias are not or are only partially filled, at least during the manufacturing process. Defects relating to these layers can occur during the manufacturing process as well as during ongoing application, for instance due to thermal stresses and/or mechanical loads and/or chemical processes. Such defects can occur as delaminations and/or convexities or bulges and can negatively affect the electrical properties of the respective via. In the finished assembly state, defects may cause unwanted electrical properties on the basis of which the presence of defects can be detected. However, it is desirable to be able to identify or detect any defects at an earlier stage ahead of the finished assembly state.

For detailed information in connection with defects that may be expected in vias, reference is made to the following prior art:
De Wolf, Ingrid, Kristof Croes, and Eric Beyne. “Expected failures in 3-D technology and related failure analysis challenges.” IEEE Transactions on Components, Packaging and Manufacturing Technology 8.5 (2018): 711-718.
Vartanian, Victor, et al. “Metrology needs for through-silicon via fabrication.” Journal of Micro/Nanolithography, MEMS, and MOEMS 13.1 (2014): 011206-011206.
Tsuto, Takashi, et al. “Advanced through-silicon via inspection for 3D integration.” Transactions of The Japan Institute of Electronics Packaging 6.1 (2013): 13-17.
Li, Yan, Purushotham Kaushik Muthur Srinath, and Deepak Goyal. “A review of failure analysis methods for advanced 3D microelectronic packages.” Journal of Electronic Materials 45 (2016): 116-124.
Bender, Hugo, et al. “Structural characterization of through silicon vias.” Journal of Materials Science 47 (2012): 6497-6504.

A number of conceivable approaches for detecting possible defects are known from the prior art. Electrical metrological processes, acoustic microscopy (SAM), relating in particular to surface acoustic waves (SAWs), infrared microscopy (IR microscopy), X-ray microscopy (XRM), microtomography (μ-CT), lock-in thermography (LIT), photo-emission microscopy (PEM), time-of-flight secondary ion mass spectrometry (ToF-SIMS), atomic force microscopy (AFM), may be cited as examples. In addition, methods that are not nondestructive for detecting possible defects are also known, for instance the embedding of a microelectronic component in synthetic resin and the slicing and grinding of said sample in order to obtain a cross-section on the basis of which further investigations in respect of the defect can be conducted, e.g. via scanning electron microscopy (SEM). For further details concerning the cited possibilities, reference is made to the following prior art:
Kia, Alireza M., et al. “ToF-SIMS 3D analysis of thin films deposited in high aspect ratio structures via atomic layer deposition and chemical vapor deposition.” Nanomaterials 9.7 (2019): 1035.
de Veen, P. J., et al. “High-resolution X-ray computed tomography of through silicon vias for RF MEMS integrated passive device applications.” Microelectronics Reliability 55.9-10 (2015): 1644-1648.
Cassidy, C., et al. “Depth-resolved photoemission microscopy for localization of leakage currents in through Silicon Vias (TSVs).” 2009 16th IEEE International Symposium on the Physical and Failure Analysis of Integrated Circuits. IEEE, 2009.

A number of publications in connection with vias are also known from patent literature, e.g. US 2014/0 064 445 A1, US 2015/0 192 527 A1, JP 2016-085 045 A, US 2015/0 226 676 A1, CN 1 10911 301 A, U.S. Pat. No. 10,352,879 B2, WO 2021/084 933 A1, US 2017/0 067 732 A1 and WO 2023/054 910 A. Others that should be cited in this regard include e.g. U.S. Pat No. 9,810,796 B2, 10,088,578 B2, 10,156,644 B2, 10,120,082 B2, US 2022/0 066 054 A1, U.S. Pat. Nos. 11,076,822 B2 and 10,825,729 B2.

### SUMMARY

One or more example embodiments of the present invention set themselves an object of disclosing an improved concept in respect of the detection of defects in vias of microelectronic components, in particular with regard to resource-sparing feasibility and maximally reliable results.

According to one or more example embodiments of the present invention, at least this object is achieved in the case of a method of the type cited in the introduction in that image data of a hollow interior space of the via relating to at least a part of the visually visible range of the electromagnetic spectrum is acquired by an image acquisition device, in particular in relation to a viewing direction from above or externally onto the via, wherein the image data is supplied to an evaluation device by which an in particular computer-implemented evaluation of the image data is performed in order to identify the at least one defect.

One of the central ideas of one or more example embodiments of the present invention relates to the fact that the image data of the interior space of the via, as a previously unused source for information that is used in the course of the detection of defects, is provided for this purpose. In particular compared to the techniques cited in the introduction, the inventive acquisition of image data relating to the visually visible range of the electromagnetic spectrum on the one hand constitutes a comparatively simple possibility for sensory data acquisition. On the other hand, however, this database is also sufficiently suitable for enabling potential defects to be reliably identified or detected. The image data can be available as at least one two-dimensional image, i.e. at least one two-dimensional array, comprising a plurality of pixels. Each of the pixels can be assigned a value for the color and/or the intensity or brightness and/or for other parameters.

A further central point of the method according to one or more example embodiments of the present invention relates to the method step directed to the evaluation of the image data, which method step can be performed by the evaluation device and consequently by a computer and therefore automatically. By this mechanism and/or means, it is made possible for a plurality of vias to be inspected with regard to the presence of defects in a short space of time. In particular, it is possible in practice to identify those vias in which a defect is present in this process.

It is conceivable that the microelectronic component comprises a substrate, wherein the at least one via is formed by a recess in the substrate. The substrate consists of plastic or preferably silicon. To produce the via, the recess, which is e.g. a blind hole, can be incorporated into the substrate, e.g. via etching. Subsequently, an insulating layer can be applied there, e.g. via chemical, in particular electrochemical, or physical deposition of an insulating medium in order to produce an electrical insulation between the via and the material of the substrate. In the next step, a barrier layer can be applied onto the insulating layer, e.g. in order to avoid material diffusion as well as to provide a mechanical reinforcement of the via. Finally, a conductor layer consisting of an electrically conductive material, e.g. a metal such as copper, is applied to the barrier layer, for example by chemical, in particular electrochemical, or physical deposition. In this way the interior space of the via can be delimited by the conductor layer. With regard to the chemical deposition, a chemical vapor deposition (CVD) process can be performed, for example. With regard to the physical deposition, a physical vapor deposition (PVD) process can be performed, for example. The conductor layer achieves the desired electrical conductivity of the via. Following the acquisition of the image data, the interior space can be filled with an electrically conductive material, e.g. a metal such as copper, or remain free. The cited layers are located either only inside the recess or additionally in a lateral region around an aperture of the via.

The conductor layer can cover or form a base and a sidewall or sidewalls of the recess. The recess can be open toward one side. A line of sight of the image acquisition device can lead through the aperture into the interior space for the purpose of acquiring the image data. The substrate is preferably plate-shaped, wherein the aperture can be arranged in the region of one of the two planar surfaces of the substrate. With regard to the surface of the substrate located opposite the surface having the aperture, the substrate material can be ground down so that the base of the conductor layer is exposed as a contacting pin. The interior space can have an at least substantially cylindrical geometry. The line of sight of the image acquisition device during the acquisition of the image data and a longitudinal axis of said cylinder can be identical. The line of sight of the image acquisition device preferably stands at least substantially perpendicularly on the base of the via during the acquisition of the image data.

It is conceivable that the image acquisition device comprises at least one light source for generating a light, wherein the image data is acquired while the via is illuminated by the light generated by the at least one light source. For example, the light source is or comprises at least one light-emitting diode and/or at least one halogen lamp. The light may be monochromatic, in which case the present wavelength is located in the visually visible range of the electromagnetic spectrum. The light may be polychromatic, in which case its spectral distribution is located at least partially in the visually visible range of the electromagnetic spectrum. The image acquisition device may have a plurality of light sources which are situated at different positions in order to provide an illumination of the via from different directions. If only one light source is provided, this is preferably arranged at least substantially centrally above the aperture, in particular on an extension of the longitudinal axis of the cylinder describing the shape of the interior space.

The light generated by the light source is preferably polarized. The use of linearly, circularly or elliptically polarized light is conceivable in this regard. Experiments have revealed that defects are particularly clearly identifiable in the image data when polarized light is used. In particular, peripheral regions of the base adjoining the sidewall or sidewalls appear in the image data with a particularly sharp contrast when circularly polarized light is used, as a result of which defects in this region are particularly clearly identifiable. This advantageous effect is particularly strongly pronounced when circularly polarized light is used.

The image acquisition device may comprise a microscope and a camera, wherein the image data relates to a visualization of the via magnified by the microscope. In particular as the via or its aperture has a diameter of less than 100μm, a 500 to 1000 times magnification produced by the microscope is beneficial. The use of a Köhler illumination system may be provided in order to achieve an optimal illumination situation during the acquisition of the image data. The microscope may comprise multiple components, e.g. an eyepiece or an eyepiece lens, a lens revolver or changer, at least one objective lens, a tube lens and a specimen stage. The specimen stage may comprise a holder device for securing the microelectronic component. The specimen stage may be slidable along the optical axis of the microscope, in particular in order to move the via into a focal point of the microscope.

With regard to the plane standing perpendicularly on the optical axis of the microscope, the specimen stage can be movable at least in relation to one spatial direction. By a relocation of the specimen stage along this at least one spatial direction it is possible to position a plurality of vias of the microelectronic component successively into the field of view of the microscope or the camera such that multiple datasets relating to image data of one of the vias can be acquired in succession. In order to realize the relocation capability, the specimen stage can be coupled to at least one, in particular electromechanical, actuator. In this way, a control device, which is in particular the evaluation device, can be configured to generate control signals for driving the at least one actuator such that a plurality of datasets of image data of multiple vias of the microelectronic component held by the specimen stage can be successively acquired automatically.

The image data is preferably acquired in the course of a brightfield microscopy inspection. This means that the entirety of the light reflected at the via in relation to the visually visible part of the electromagnetic spectrum is captured by the image acquisition device or the camera. Basically, however, it is also conceivable to perform a darkfield microscopy inspection in which light of a specific wavelength range or having a specific polarization is used for the acquisition of the image data. For this purpose, correspondingly suitable filters and/or diaphragms may be provided in the region of the light path of the microscope and/or the camera. Further operating modes essentially practicable with microscopes may also be provided in the course of the acquisition of the image data, e.g. modes for realizing a differential interference contrast or a phase contrast or the like.

Particularly preferably, a segmentation is performed on the image data by the evaluation device, the resulting image segments being assigned to defects and/or predefined regions of the via. The image segments resulting in the course of the segmentation are contiguous sections in the respective image data or of the respective image which are assigned to a defect or predefined region of the via. The base, the sidewall or sidewalls, a surface of the microelectronic component or substrate adjacent to the via are conceivable as predefined regions in this respect. In practice, the pixels or each of the pixels are assigned to one of the image segments. The assignment is preferably accomplished in an automated manner by the evaluation device during the evaluation of the image data.

It is conceivable that a classification in respect of the type of the respective defect is carried out by the evaluation device for the detected defect or for at least one of the detected defects. In this way the appearance and/or the position of the defect in the image data can be evaluated in respect of the presence of typical features that are typically present in the case of a specific class of defects, wherein the defect or the respective image segment can be assigned to one of a plurality of predefined classifications. The classification also is preferably accomplished in an automated manner on the part of the evaluation device during the evaluation of the image data.

Particularly preferably, it is indicated on the basis of the classification that the respective defect is a delamination and/or a bulge. With regard to the delamination, it is conceivable that two neighboring layers among the above-cited layers become detached from one another, in particular due to occurring residual stresses or shear forces, which can lead to a change in the geometric structure and ultimately to the electrical properties of the via. With regard to the bulge, it is conceivable that the delamination leads to the outermost layer protruding into the interior space. Non-uniformities in the chemical or physical deposition may also lead to thickened areas, in particular in the conductor layer, which likewise leads to a bulge, and, specifically, particularly frequently in the region of the base.

The results thus obtained, i.e. the presence of at least one defect in a specific via and possibly the respectively associated classification, can be output by an output device and/or stored in a readable file and thus made available to a user for further evaluation.

The evaluation of the image data for identifying the at least one defect can be conducted using an artificial intelligence app. Compared to an evaluation of the image data performed by a human user, the use of the artificial intelligence app produces an increase in efficiency in terms of the resources required for this, in particular as regards time. A further advantageous effect is that a multiplicity of factors and correlations that would tax the comprehension of the human user can be taken into account by artificial intelligence. Consequently, the result of the evaluation of the image data, i.e. the detection of any defects and possibly the segmentation and/or classification, is extremely promising in terms of the correct identification of defects. Particularly preferably, the artificial intelligence app is realized as a trained model generated by a machine learning process.

The present invention further relates to a detection device for performing the method according to the foregoing description, said detection device comprising an image acquisition device by which, in particular with reference to a line of sight from above or outside onto the via, image data of a hollow interior space of the via relating to at least a part of the visually visible range of the electromagnetic spectrum can be acquired, and an evaluation device to which the image data can be supplied and by which an evaluation of the image data can be carried out in order to identify the at least one defect. All the advantages, features and aspects described in connection with the method according to one or more example embodiments of the present invention are equally applicable to the detection device according to one or more example embodiments of the present invention, and vice versa.

One or more example embodiments of the present invention further relate to a computer-readable storage medium. The object of the present invention is inventively achieved with such a storage medium in that the latter comprises instructions which, when they are executed by a processing device designed as a computer, cause the processing device to perform the method according to the above description, in particular at least the step relating to the evaluation of the image data. All the advantages, features and aspects explained in connection with the method according to one or more example embodiments of the present invention and the detection device according to one or more example embodiments of the present invention are equally applicable to the computer-readable storage medium according to one or more example embodiments of the present invention, and vice versa.

In addition, the present invention relates to an evaluation device. The object of the present invention is inventively achieved with such an evaluation device in that the latter comprises a computer-readable storage medium according to the foregoing passage of the description and a processing device, wherein the instructions, when executed by the processing device designed as a computer, cause the processing device to perform the method according to the above description, in particular at least the step relating to the evaluation of the image data. All the advantages, features and aspects explained in connection with the method according to one or more example embodiments of the present invention, the detection device according to one or more example embodiments of the present invention and the storage medium according to one or more example embodiments of the present invention are equally applicable to the evaluation device according to one or more example embodiments of the present invention, and vice versa.

Finally, one or more example embodiments of the present invention relate to a computer-implemented method for generating a trained model which can be used in the method according to the above description in the course of the evaluation of the image data for the purpose of identifying the at least one defect, wherein the method comprises the following steps:
specifying at least one training input dataset,
specifying a training result which is assigned to the at least one training input dataset,
training a model based on the at least one training input dataset and the training result, as a result of which the trained model is obtained.

With regard to the model, a training or machine learning process is performed. In this way the trained model realizes cognitive functions corresponding or at least similar to the example of human reasoning. Via the completion of the training, the model is in principle capable of revealing and making use of hitherto unrecognized relationships and patterns. In this way the determination of variables and/or factors and/or correlations by the model can be developed further and improved by way of the performance of the training. In the training, separate training steps or cycles can be performed successively, the model steadily improving in the process. In practice, a supervised training can take place, although it is also conceivable to carry out an unsupervised training.

Real datasets available in the past or image data relating to vias can be used as the training input datasets. If the supervised training is conducted, then results specified on the user side in respect of the defects can be predefined from this as ideal solutions which are used as the training results. The results generated in the course of the training via the model can be compared with these, a minimization of the deviations between the training results and the generated results being provided as the specified objective. When a model based on a neural network is used, the image data or the training input datasets are supplied to the model via an input layer of the same, the results of the evaluation being provided via an output layer of the model. A large number of further layers may be present therebetween, each comprising a certain number of nodes between which connections for implementing a neural network are established in the course of the training. Details in this regard are sufficiently well-known to the person skilled in the art and are therefore not explained in greater depth. It should furthermore be noted that all the advantages, features and aspects explained in connection with the above-explained method according to one or more example embodiments of the present invention, the detection device according to one or more example embodiments of the present invention, the storage medium according to one or more example embodiments of the present invention and the evaluation device according to one or more example embodiments of the present invention are equally applicable to this method according to one or more example embodiments of the present invention, and vice versa.

### BRIEF DESCRIPTION OF THE DRAWINGS

Further advantages, features and details of the present invention will become apparent from the exemplary embodiments presented in the following, as well as with reference to the schematic figures, in which:

FIG. 1 shows a cutaway view of a section of a microelectronic component in the region of a via,

FIG. 2 shows an arrangement for performing an inventive method according to an exemplary embodiment relating to the microelectronic component of FIG. 1, comprising an inventive detection device according to an exemplary embodiment and an inventive evaluation device according to an exemplary embodiment having an inventive computer-readable storage medium according to an exemplary embodiment, and

FIG. 3, FIG. 4 and FIG. 5 show example illustrations of image data acquired while the method explained with reference to FIG. 2 is being performed.

### DETAILED DESCRIPTION

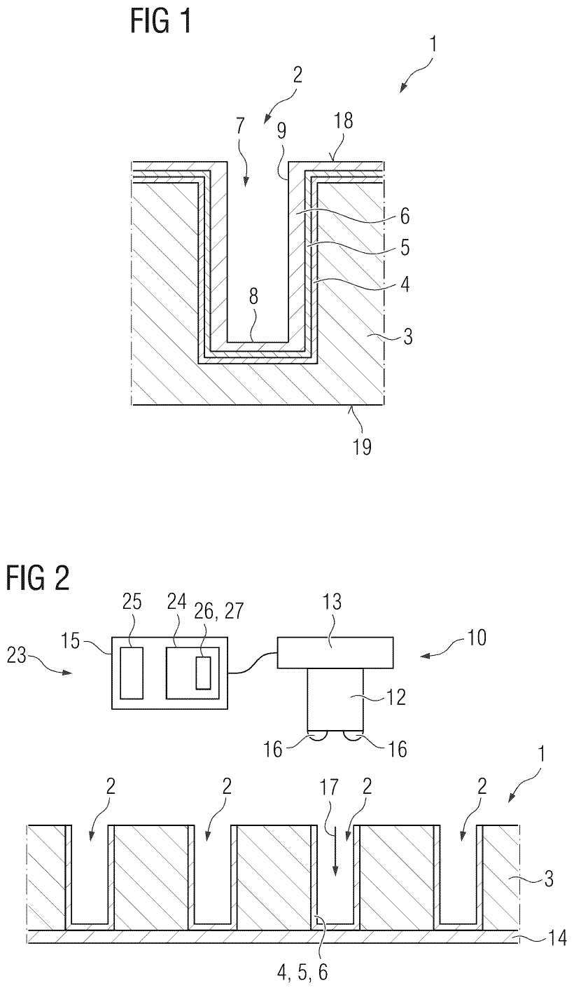

FIG. 1 shows a cutaway view through a microelectronic component 1 in the region of a via 2, wherein the microelectronic component 1 is provided by way of example as a component of a detector of a computed tomography device. Although only one via 2 is shown in FIG. 1, as will become clear in the following with reference to FIG. 2, the microelectronic component 1 comprises a plurality of vias 2 arranged in a row. The aspects presented below with reference to the via 2 shown in FIG. 1 are essentially equally applicable to all further vias 2 of the microelectronic component 1.

The microelectronic component comprises a plate-shaped substrate 3 made of silicon, wherein the via 2 is embodied as a recess representing a blind hole in the substrate 3 which has been incorporated into the silicon by etching. Provided in the region of the via 2 are a plurality of layers 4, 5, 6 arranged one above the other, specifically an insulating layer 4, a barrier layer 5 and a conductor layer 6. The insulating layer 4 was applied by chemical, in particular electrochemical, and/or physical deposition of an insulating material onto the silicon of the substrate 3 and serves to provide an electrical insulation between the via 2 and the substrate 3. The barrier layer 5 situated above the insulating layer 4 serves to avoid material diffusion as well as to provide mechanical reinforcement for the via 2. The uppermost layer is a conductor layer 6 and consists of an electrically conductive material, specifically a metal such as e.g. copper, and is formed by chemical, in particular electrochemical, and/or physical deposition. The conductor layer 6 provides the desired electrical conductivity of the via 2. The layers 4, 5, 6 are located inside the recess and in addition extend into a side area around an aperture of the via 2. The aperture is arranged in the region of one of the two planar surfaces 18, 19 of the substrate 3. In the state shown in FIG. 1, substrate material is present on the surface 19 of the substrate 3 arranged opposite the aperture of the via 2, which substrate material still needs to be abraded. This causes the conductor layer 6 to provide an exposed contacting point on the surface 19 forming the underside of the substrate 3. With regard to the chemical or physical deposition, it is provided in the present example that a chemical or physical vapor deposition process has been performed.

Thus, the via 2 has a hollow interior space 7 which is open toward the top and possesses an at least substantially cylindrical geometry. The hollow interior space 7 is bounded by the conductor layer 6, which is composed of a base 8 and a hollow cylindrical sidewall 9. The via 2 enables an electrical contact to be established between the two opposite planar surfaces of the substrate 3.

The object of the below-explained inventive method according to an exemplary embodiment is to identify or detect potential defects 20 in the vias 2 by automated devices, mechanisms and/or means. Typical defects 20 are e.g. delaminations and/or convexities or bulges relating to the layers 4, 5, 6, which negatively affect the conductivity and therefore the functionality of the via 2. FIG. 2 shows a structure for performing the method, wherein, according to this illustration, a plurality of vias 2 of the microelectronic component 1 can be seen. In the state shown, the lower part of the substrate 3 is also ground down such that the bases 8 of the vias 2 are exposed downward as contacting points.

The arrangement shown in FIG. 2 comprises an image acquisition device 10 by which image data 11 of the vias 2 is acquired. The image acquisition device 10 comprises a microscope 12 and a camera 13, wherein the image data 11 relating to the visually visible part of the electromagnetic spectrum is a visualization magnified by the microscope 12 or a corresponding image of the respective via 2. The via 2 has a diameter of approx. 50 μm, for example, a 500 to 1000 times magnification being attained by the microscope 12. In the exemplary embodiment shown, the line of sight of the image acquisition device 10 corresponds to an optical axis of the microscope 12, which axis in the present example extends along the vertical direction of FIG. 2. Therefore, the line of sight of the image acquisition device 10 stands at least substantially perpendicularly on the base 8 of the via 2 such that the image data 11 shows the hollow interior space 7 of the respective via 2 in each case.

The microscope 12 comprises a plurality of components which for clarity of illustration reasons are not shown in FIG. 2, specifically an eyepiece or an eyepiece lens, a lens revolver or changer, objective lenses and a tube lens. Also provided is a specimen stage 14 comprising a holder device by which the microelectronic component 1 is secured hereto. In order to enable the via 2 to be positioned into a focal point of the microscope 12, the specimen stage 14 is movable along the optical axis of the microscope 12. With regard to the plane standing perpendicularly on the optical axis of the microscope 12, the specimen stage 14 is movable in relation to the two further spatial directions. In this way it is made possible to place the vias 2 successively into the field of view of the microscope 12. In order to implement the ability to move along the cited directions, the specimen stage 14 is coupled to a plurality of electromechanical actuators which can be driven by a control device, which in the present example is also an evaluation device 15. For this purpose, the control device generates control signals that are output to the actuators and cause the vias 2 to be moved one after the other into the field of view of the microscope 12 in order to acquire a plurality of datasets of image data 11 of the vias 2 in succession.

As an example, the image data 11 is acquired in the course of a brightfield microscopy inspection in which the entirety of the light of the visually visible part of the electromagnetic spectrum is reflected off the via 2 and subsequently is captured by the image acquisition device 10. With regard to an optimal illumination situation, a Köhler illumination system is provided for the microscope 12. The image acquisition device 10 or the microscope 12 comprises a plurality of light sources 16 embodied as light-emitting diodes and/or halogen lamps for generating circularly polarized light 17, the image data 11 being acquired while the via 2 is illuminated by said light 17. A linearly or elliptically polarized light or an unpolarized light may also be used instead of the circularly polarized light 17.

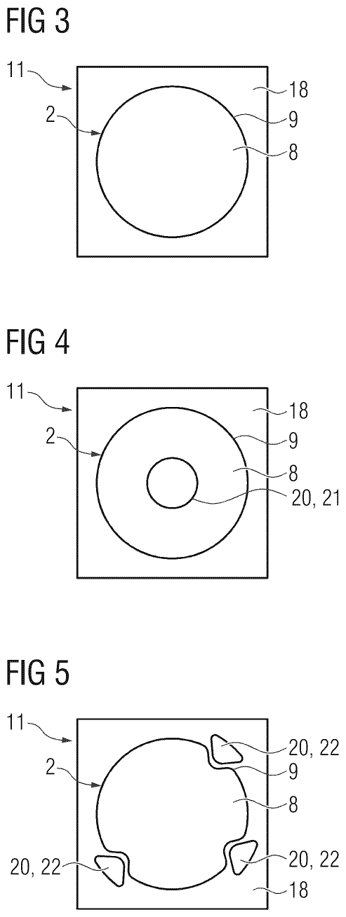

Examples of image data 11 acquired in this way are shown in FIGS. 3 to 5. The image data 11 assigned to the respective via 2 is present as a two-dimensional image, i.e. a two-dimensional array, comprising a plurality of pixels. Each of the pixels is assigned a value for the color and a value for the brightness. The image data 11 is present for each of the vias 2 as an image of the respective hollow interior space 7. In the case of the via 2 of the image data 11 shown with reference to FIG. 3, no defect 20 is present. In the case of the via 2 of the image data 11 shown with reference to FIG. 4, a central bulge 21 is present as a defect 20 in the region of the base 9. In the case of the via 2 of the image data 11 shown with reference to FIG. 5, several delaminations 22 are present as defects 20 in the region of the sidewall 9.

In order to identify said defects 20, the image data 11 is supplied to the inventive evaluation device 15, which is implemented in accordance with an exemplary embodiment. A computer-implemented and automated evaluation of the image data 11 is performed by the evaluation device 15. The image acquisition device 10, in combination with the evaluation device 15, forms an inventive detection device 23 in accordance with an exemplary embodiment. The evaluation device 15 comprises an inventive computer-readable storage medium 24 in accordance with an exemplary embodiment and a processing device 25. Instructions 26 are stored on the storage medium 24 which, when they are executed by the processing device 25 embodied as a computer, cause the latter to conduct the evaluation of the image data 11 as explained in the following. The image data 11 is evaluated using the instructions 26 implementing an artificial intelligence app 27. The artificial intelligence app 27 is realized as a trained model generated by a machine learning process.

In the course of the evaluation of the image data 11, as a first step, a segmentation of the image data 11 is performed by the artificial intelligence app 27. An assignment is then carried out for the resulting image segments to indicate whether the section of the image being visualized in the respective segment shows the base 8, the sidewall 9 or the surface 18. A further assignment is carried out to determine whether the respective segment indicates a defect 20. The image segments resulting in the course of the segmentation are contiguous regions in the respective image data 11 or the respective image that are assigned to one of these identified regions.

In the next step, a classification in respect of the type of the respective defect 20 is carried out for the possibly detected defects 20 by the artificial intelligence app 27. In practice, the appearance and the position of the respective defect 20 in the image data 11 are evaluated in terms of typical features for specific types of defects. If typical features are present, then the defect 20 is assigned to a predefined classification. As possible classifications, it is determined in this process whether the respective defect 20 is a bulge 21 or a delamination 22.

Finally, the results generated in this way are output via an output device (not shown in more detail in the figures) and/or stored in a correspondingly readable file and thus made available to a user for further evaluation.

In conclusion, an inventive method according to an exemplary embodiment is explained which is directed to the generation of a trained model that is used in the course of the previously described evaluation of the image data 11 for the purpose of identifying the at least one defect 20. In a first step, training input datasets are specified which are available in the form of image data 11 according to the foregoing description. This image data 11 is historical data, an associated training result being specified for each of the input datasets. The training result indicates whether a defect 20 is present in the case of the via 2 which is assigned to the respective historical or image data 11 and whether this relates to a bulge 21 or a delamination 22. The results obtained by the artificial intelligence app 27 or the model to be trained are compared with the training result, a specified objective consisting in aiming to achieve a minimization of the deviations between the training results and the results generated by the artificial intelligence app 27. The above-described trained model is obtained by this mechanism and/or means.

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of”has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,”etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

What is claimed is:

1. A method for detecting at least one defect in at least one hollow via of a microelectronic component, the method comprising:
acquiring, via an image acquisition device, image data of a hollow interior space of the at least one hollow via relating to at least a part of a visually visible range of an electromagnetic spectrum;
supplying the image data to an evaluation device; and
evaluating, via the evaluation device, the image data to identify the at least one defect.

2. The method as claimed in claim 1, wherein at least one of
the microelectronic component includes a substrate,
the at least one hollow via is formed by a recess in the substrate, or
the hollow interior space of the at least one hollow via is bounded by a layer composed of a metal that is applied via chemical or physical deposition.

3. The method as claimed in claim 1, wherein
the image acquisition device comprises at least one light source configured to generate light, and
the image data is acquired while the at least one hollow via is illuminated by the light generated by the at least one light source.

4. The method as claimed in claim 3, wherein the light is polarized.

5. The method as claimed in claim 1, wherein a line of sight of the image acquisition device stands at least substantially perpendicularly on a base of the at least one hollow via during acquisition of the image data.

6. The method as claimed in claim 1, wherein
the image acquisition device comprises a microscope and a camera, and
the image data relates to a visualization of the at least one hollow via magnified via the microscope.

7. The method as claimed in claim 6, wherein acquisition of the image data is performed in the course of at least one of (i) a brightfield microscopy or a darkfield microscopy inspection, or (ii) an operating mode for implementing a differential interference contrast or a phase contrast.

8. The method as claimed in claim 1, further comprising:
segmenting the image data via the evaluation device, wherein
resulting image segments are assigned to at least one of defects or defined regions of the at least one hollow via.

9. The method as claimed in claim 1, further comprising:
performing, via the evaluation device, a classification of a type of a respective defect for a detected defect or for at least one detected defect.

10. The method as claimed in claim 9, further comprising:
indicating, based on the classification, that the respective defect is at least one of a delamination or a bulge.

11. The method as claimed in claim 1, wherein the evaluating evaluates the image data to identify the at least one defect using an artificial intelligence application.

12. A detection device for performing the method as claimed in claim 1, the detection device comprising:
the image acquisition device configured to acquire image data of the hollow interior space of the at least one hollow via; and
the evaluation device configured to receive and evaluate the image data to identify the at least one defect.

13. A non-transitory computer-readable storage medium comprising instructions that, when executed by a processing device, cause the processing device to perform the method as claimed in claim 1.

14. An evaluation device comprising:
the non-transitory computer-readable storage medium as claimed in claim 13; and
a processing device configured to execute the instructions.

15. A computer-implemented method for generating a trained model usable in the method as claimed in claim 1 in the course of evaluating the image data to identify the at least one defect, wherein the computer-implemented method comprises:
specifying at least one training input dataset;
specifying a training result assigned to the at least one training input dataset; and
training a model based on the at least one training input dataset and the training result, to obtain the trained model.

16. The method as claimed in claim 2, wherein at least one of
the substrate is comprised of silicon,
the at least one hollow via is formed by etching the substrate, or
the metal is copper.

17. The method as claimed in claim 4, wherein the light is polarized circularly.

18. The method as claimed in claim 8, wherein the defined regions of the at least one hollow via include a base or a sidewall of the at least one hollow via.

19. The method as claimed in claim 11, wherein the artificial intelligence application is a trained model generated via a machine learning process.

20. The method as claimed in claim 3, further comprising:
performing, via the evaluation device, a classification of a type of a respective defect for a detected defect or for at least one detected defect.
